(19) United States
(12) Patent Application Publication
(10) Pub. No.: US 2026/0228851 A1
(43) Pub. Date: Aug. 6, 2026

(54) CACHE OPTIMIZATION FOR REPROJECTION PROCESSING

(71) Applicant: QUALCOMM Incorporated, San Diego, CA (US)

(72) Inventors: Priyanka PALANI, San Diego, CA (US); Wesley James HOLLAND, Encinitas, CA (US)

(21) Appl. No.: 19/047,490

(22) Filed: Feb. 6, 2025

(51) Int. Cl. G06T 1/60; G06F 9/50

(52) U.S. Cl. CPC G06T 1/60; G06F 9/5016

(57) ABSTRACT

This disclosure provides systems, devices, apparatus, and methods, including computer programs encoded on storage media, for optimizing memory allocation for reprojection stages. A graphics processor may obtain a set of frame processing metrics from a plurality of reprojection processing stages. The graphics processor may determine an estimated bandwidth savings for each reprojection processing stage of the plurality of reprojection processing stages based on the set of frame processing metrics. The graphics processor may determine a priority for each of the plurality of reprojection processing stages based on the determined estimated bandwidth savings. The graphics processor may allocate a portion of a first memory to a set of reprojection processing stages of the plurality of reprojection processing stages based on the determined priority for each of the plurality of reprojection processing stages.

### TECHNICAL FIELD

The present disclosure relates generally to processing systems, and more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques may not address efficient use of memory when the memory is insufficient to store all layers for reprojection processing. There is a need for improved memory utilization techniques for reprojection processing.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include memory, and at least one processor coupled to the memory and, based at least in part on information stored in the memory, the at least one processor may be configured to obtain a set of frame processing metrics from a plurality of reprojection processing stages. The at least one processor may be configured to determine an estimated bandwidth savings for each reprojection processing stage of the plurality of reprojection processing stages based on the set of frame processing metrics. The at least one processor may be configured to determine a priority for each of the plurality of reprojection processing stages based on the determined estimated bandwidth savings. The at least one processor may be configured to allocate a portion of a first memory to a set of reprojection processing stages of the plurality of reprojection processing stages based on the determined priority for each of the plurality of reprojection processing stages.

In some aspects, the techniques described herein relate to a method of graphics processing, including: obtaining a set of frame processing metrics from a plurality of reprojection processing stages; determining an estimated bandwidth savings for each reprojection processing stage of the plurality of reprojection processing stages based on the set of frame processing metrics; determining a priority for each of the plurality of reprojection processing stages based on the determined estimated bandwidth savings; and allocating a portion of a first memory to a set of reprojection processing stages of the plurality of reprojection processing stages based on the determined priority for each of the plurality of reprojection processing stages.

In some aspects, the techniques described herein relate to a method, further including: storing a set of layers processed by the set of reprojection processing stages on the allocated portion of the first memory after the allocation of the portion of the first memory.

In some aspects, the techniques described herein relate to a method, where determining the priority for each of the plurality of reprojection processing stages based on the determined estimated bandwidth savings includes: determining a priority ranking table for the plurality of reprojection stages for a first frame of a plurality of frames, further including: storing the priority ranking table on a second portion of the first memory.

In some aspects, the techniques described herein relate to a method, further including: allocating a portion of an off-chip memory to a second set of reprojection processing stages of the plurality of reprojection processing stages based on the determined priority for each of the plurality of reprojection processing stages.

In some aspects, the techniques described herein relate to a method, further including: storing a second set of layers processed by the second set of reprojection stages on the allocation portion of the off-chip memory after the allocation of the portion of the off-chip memory.

In some aspects, the techniques described herein relate to a method, where the set of frame processing metrics includes at least one of: a frame rate associated with a reprojection stage of the plurality of reprojection stages; a resolution associated with the reprojection stage; a fill rate associated with the reprojection stage; or an identifier associated with the reprojection stage.

In some aspects, the techniques described herein relate to a method, where determining the estimated bandwidth savings for each reprojection stage of the plurality of reprojection processing stages based on the set of frame processing metrics includes: determining the estimated bandwidth savings for the reprojection stage based on the frame rate, the resolution, and the fill rate associated with the reprojection stage.

In some aspects, the techniques described herein relate to a method, where determining the priority for each of the plurality of reprojection processing stages based on the determined estimated bandwidth savings includes: determining a first priority ranking for the plurality of reprojection stages for a first frame of a plurality of frames; and determining a second priority ranking for the plurality of reprojection stages for a second frame of the plurality of frames, where allocating the portion of the first memory to the set of reprojection processing stages of the plurality of reprojection processing stages based on the determined priority for each of the plurality of reprojection processing stages includes: allocating a first portion of the first memory to a first set of reprojection processing stages of the plurality of reprojection processing stages based on the determined first priority ranking; and allocating a second portion of the first memory to a second set of reprojection processing stages of the plurality of reprojection processing stages based on the determined second priority ranking, where the first set of reprojection processing stages is different from the second set of reprojection processing stages.

In some aspects, the techniques described herein relate to a method, where the plurality of reprojection processing stages includes at least one of: a video processing stage; a graphics processing stage; a color space conversion stage; or a reprojection stage.

In some aspects, the techniques described herein relate to a method, where allocating the portion of the first memory to the set of reprojection processing stages of the plurality of reprojection processing stages based on the determined priority for each of the plurality of reprojection processing stages includes: allocating the portion of the first memory to a reprojection processing stage of the plurality of reprojection processing stages based on the determined priority for each of the plurality of reprojection processing stages, further including: allocating a portion of an off-chip memory to the reprojection processing stage of the plurality of reprojection processing stages based on the determined priority for each of the plurality of reprojection processing stages; storing a first set of layers processed by the reprojection processing stage on the allocated portion of the first memory after the allocation of the portion of the first memory; and storing a second set of layers processed by reprojection processing stage on the allocated portion of the off-chip memory after the allocation of the portion of the off-chip memory.

In some aspects, the techniques described herein relate to a method, further including: write-protecting the allocated portion of the first memory after storage of the first set of layers processed by the reprojection processing stage, where storage of the second set of layers on the allocated portion of the off-chip memory occurs after the write-protection of the allocated portion of the first memory.

In some aspects, the techniques described herein relate to a method, further including: selecting a compression scheme based on the set of frame processing metrics; compressing a set of layers processed by the set of reprojection processing stages based on the selected compression scheme; and storing the compressed set of layers on the allocated portion of the first memory after the allocation of the portion of the first memory.

In some aspects, the techniques described herein relate to a method, where selecting the compression scheme based on the set of frame processing metrics includes: selecting the compression scheme based on a fill-rate associated with a reprojection stage of the plurality of reprojection stages; or selecting the compression scheme based on a frame rate associated with the reprojection stage of the plurality of reprojection stages.

In some aspects, the techniques described herein relate to a method, where selecting the compression scheme based on the set of frame processing metrics includes: selecting the compression scheme based on a type of hardware data path associated with a reprojection stage of the plurality of reprojection stages.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example GPU in accordance with one or more techniques of this disclosure.

FIG. 3 illustrates an example of a reprojection system on a chip, in accordance with one or more techniques of this disclosure.

FIG. 4A illustrates an example of sparse content that may be processed by a reprojection processing stage, in accordance with one or more techniques of this disclosure.

FIG. 4B illustrates an example of sparse content that may be processed by a reprojection processing stage, in accordance with one or more techniques of this disclosure.

FIG. 5 illustrates an example of a reprojection system on a chip, in accordance with one or more techniques of this disclosure.

FIG. 6 illustrates a method of determining a priority ranking for a plurality of reprojection processing stages, in accordance with one or more techniques of this disclosure.

FIG. 7 illustrates an example of a reprojection system on a chip, in accordance with one or more techniques of this disclosure.

FIG. 8 illustrates a method of determining a priority ranking for a plurality of reprojection processing stages and a compression scheme for a set of layers, in accordance with one or more techniques of this disclosure.

FIG. 9 is a call flow diagram illustrating example communications between a control unit and a system on a chip (SOC) in accordance with one or more techniques of this disclosure.

FIG. 10 is a flowchart of an example method of graphics processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, off-chip memory not on the processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

The following description is directed to examples for the purposes of describing innovative aspects of this disclosure. However, a person having ordinary skill in the art may recognize that the teachings herein may be applied in a multitude of ways. Some or all of the described examples may be implemented in any device or system that is capable of processing graphics commands. Various aspects relate generally to reprojecting and/or composing frames for a graphics processing unit (GPU). Some aspects more specifically relate to applying reprojection fallback strategies during an excess system load (e.g., when a reprojection process for a frame will not complete in time to display the frame). For example, a graphics system may have limited dynamic random access memory (DRAM) bandwidth due to concurrent work (e.g., rendering, GPU workload, high-intensity periods of camera data acquisition), software control latencies (e.g., poorly optimized code, latencies when communicating with third-party applications), bottlenecking hardware execution, and/or power/thermal throttling. Such loads may affect the calculated projected time for a reprojection process to complete within a threshold period of time. Use of remotely rendered framebuffers (e.g., frames processed by a reprojection topology on a separate system, or a third-party system), may also affect the time to render a frame. For example, use of a second reprojection process may conserve resources if a first reprojection process uses remote-rendered framebuffers having a high calculated latency value, or if a first reprojection process uses a large amount of bandwidth (e.g., WiFi, 5G bandwidth) and a system is configured to conserve use of that bandwidth with respect to transmission/reception of remote-rendered frames.

Extended reality (XR) devices may leverage a technique called late-stage reprojection (LSR) to efficiently update display-frames prior to display. After a layer has been rendered, a user of a head-mounted display (HMD) may move their head, changing the angle at which they are viewing an object in a display. Instead of performing a complete re-render of a rendered layer, an XR device may perform LSR on the layer (e.g., warping the layer) to reduce the end-to-end (e.g., machine to people (M2P) latency. The rendered layer may be rendered locally on the client device (e.g., the HMD) or remotely on a remote device (e.g., a server, a companion device), which may then be transmitted to the HMD, which may then perform LSR on the rendered layers. Remote rendered layers may have different hardware processing paths than locally rendered layers. As a result, remote rendered layers may also have different fill rates and/or frame refresh rates. A frame refresh rate may be the number of frames a reprojection processing stage handles per second, which may be expressed in frames per second (fps). A fill rate may be the number of pixels of a frame that may be drawn at a given frame refresh rate (e.g., 100% of the frame at 60 fps, 50% of the frame at 90 fps). A reprojection processing stage may be a stage, function, or component of a system on a chip (SOC) that processes a layer or a frame for LSR. The reprojection processing stage may include, for example, a video processing stage, a graphics processing stage, a color space conversion stage, or a reprojection stage.

For a reprojection processing stage to process a layer or a frame for LSR, the reprojection processing stage may use a portion of a first memory (e.g., on-chip memory, cache), to minimize processing delays. Each reprojection stage may have a different cache footprint at each stage of an LSR pipeline. Since the total amount of the first memory may be limited, some reprojection processing stages may be configured to use portions of the first memory for storage, while other reprojection processing stages may be configured to use portions of a second memory (e.g., off-chip memory, system memory, hard disk memory) for storage. In some aspects, the first memory may be memory that is located on a SOC (e.g., on-chip memory, or memory on the SOC) and the second memory may be memory that is not located on the same SOC (e.g., off-chip memory, or memory not on the SOC). In other aspects, the first memory may be memory where data can be stored by a reprojection processing stage of a SOC within a threshold amount of time, and the second memory may be memory where data cannot be stored by the reprojection processing stage of the SOC within the same threshold amount of time. In other aspects, the first memory may be memory from which data can be loaded by a reprojection processing stage of a SOC within a threshold amount of time, and the second memory may be memory from which data cannot be loaded by the reprojection processing stage of the SOC within the same threshold amount of time. In some aspects, a reprojection optimization engine may perform predictive computation to determine an estimated bandwidth savings for each reprojection processing stage. The estimated bandwidth savings may be calculated as an amount of bandwidth saved per memory unit used by the reprojection processing stage (e.g., output from the reprojection stage stored on a first memory to be used as an input to a second reprojection processing stage). For example, a reprojection processing engine may estimate a reprojection processing stage that saves its output to a first memory to save a number of megabits per second (Mb/s) of bandwidth per megabyte (MB) of data stored on the first memory. The reprojection optimization engine may rank the estimated bandwidth savings in a priority ranking table. In other words, the reprojection optimization engine may maintain a scoreboard of various producer-consumer clients accessing the cache, where a producer client is a component that produces data to store on the cache, and a consumer client is a component that reads data from the cache. An example of the producer-consumer client in the processing stages may be graphics engine-color conversion engine, wherein the color conversion stage consumes the data produced by graphics engine. The priority ranking table may utilize an evaluation factor of potential bandwidth savings per MB of cache used by the reprojection processing stages. The priority ranking table may have higher weight for a producer-consumer pair with higher savings, particularly when accounting for expected frame rates, resolution and fill rates for a reprojection optimization engine. The reprojection optimization engine may allocate the first memory to the reprojection processing stages having the highest estimated bandwidth savings per memory unit saved on the first memory (e.g., on-chip cache). The reprojection optimization engine may allocate a portion of a second memory to the remaining reprojection processing stages that have relatively lower estimated bandwidth savings. The reprojection optimization engine may dynamically recalculate the priority ranking table, shifting the priority allocation for the first memory for each frame processed by the reprojection optimization engine. In other words, based on the estimated bandwidth savings (e.g., predicted bandwidth savings per MB for on-chip cache at a frame level), the cache priorities of the hardware clients may be dynamically updated per frame basis, ensuring efficient cache usage.

In some examples, a graphics processor (or graphics processor system) may obtain a set of frame processing metrics from a plurality of reprojection processing stages. The set of frame processing metrics may include, for example, a frame rate (e.g., 60 fps, 90 fps), a resolution (e.g., 720p, 1080p), a fill rate (e.g., 50%, 75%, 100%), and/or an identifier of the reprojection processing stage. The graphics processor may utilize the reprojection processing stages to perform LSR on a set of layers rendered remotely or locally on a SOC. The graphics processor may determine an estimated bandwidth savings per memory unit (e.g., per MB) for each reprojection processing stage of the plurality of reprojection processing stages based on the set of frame processing metrics. The graphics processor may determine a priority for each of the plurality of reprojection processing stages based on the determined estimated bandwidth savings per MB. For example, a reprojection processing stage with comparatively larger estimated bandwidth savings per memory unit may be assigned a higher priority value than a reprojection processing stage with a comparatively smaller estimated bandwidth savings per memory unit. The graphics processor may allocate a portion of a first memory (e.g., on-chip memory) to a set of reprojection processing stages of the plurality of reprojection processing stages based on the determined priority for each of the plurality of reprojection processing stages. For example, the graphics processor may allocate portions of the first memory to the reprojection processing stages having the highest estimated bandwidth savings until the amount of unallocated space on the first memory falls below a threshold level, and may allocate a portion of a second memory to the remaining reprojection stages having comparatively lower estimated bandwidth savings. The first memory may include an on-chip cache. The plurality of reprojection processing stages may include a video processing stage, a graphics processing stage, a color space conversion stage, and/or a reprojection stage.

The graphics processor may store a set of layers processed by the set of reprojection processing stages on the allocated portion of the first memory after the allocation of the portion of the first memory. The set of layers may be raw frames/layers that the reprojection processing stage has yet to process, intermediate frames/layers that the reprojection processing stage has processed but is not yet ready to output to another stage, and/or final product frames/layers that the reprojection processing stage will output to another stage of the LSR. A frame may comprise a plurality of layers. In some aspects, the graphics processor may compose a frame based on a plurality of layers. To determine the priority for each of the plurality of reprojection processing stages based on the determined estimated bandwidth savings per memory unit, the graphics processor may determine a priority ranking table for the plurality of reprojection stages for a first frame of a plurality of frames. The graphics processor may store the priority ranking table on a second portion of the first memory, ensuring that the graphics processor may rapidly refer to the priority ranking table when allocating portions of the first memory and/or portions of the second memory. The graphics processor may allocate a portion of a second memory to a second set of reprojection processing stages of the plurality of reprojection processing stages based on the determined priority for each of the plurality of reprojection processing stages. For example, the graphics processor may allocate portions of a second memory to the comparatively lower priority reprojection processing stages. The second memory may include dynamic random-access memory (DRAM) of a GPU. The graphics processor may store a second set of layers processed by the second set of reprojection stages on the allocation portion of the second memory after the allocation of the portion of the second memory.

To determine the estimated bandwidth savings per memory unit for each reprojection stage of the plurality of reprojection processing stages based on the set of frame processing metrics, the graphics processor may determine the estimated bandwidth savings for the reprojection stage based on the frame rate, the resolution, and the fill rate associated with the reprojection stage. To determine the priority for each of the plurality of reprojection processing stages based on the determined estimated bandwidth savings per memory unit, the graphics processor may determine a first priority ranking for the plurality of reprojection stages for a first frame of a plurality of frames and determine a second priority ranking for the plurality of reprojection stages for a second frame of the plurality of frames. In other words, the graphics processor may determine the priority ranking at the frame level, dynamically updating the priority ranking on a per-frame basis, ensuring efficient cache usage. To allocate the portion of the first memory to the set of reprojection processing stages of the plurality of reprojection processing stages based on the determined priority for each of the plurality of reprojection processing stages, the graphics processor may allocate a first portion of the first memory to a first set of reprojection processing stages of the plurality of reprojection processing stages based on the determined first priority ranking and allocate a second portion of the first memory to a second set of reprojection processing stages of the plurality of reprojection processing stages based on the determined second priority ranking, where the first set of reprojection processing stages is different from the second set of reprojection processing stages. In other words, the graphics processor may also re-allocate portions of the first memory at the frame level.

To allocate the portion of the first memory to the set of reprojection processing stages of the plurality of reprojection processing stages based on the determined priority for each of the plurality of reprojection processing stages, the graphics processor may allocate the portion of the first memory to a reprojection processing stage of the plurality of reprojection processing stages based on the determined priority for each of the plurality of reprojection processing stages and allocate a portion of a second memory to the reprojection processing stage of the plurality of reprojection processing stages based on the determined priority for each of the plurality of reprojection processing stages. In other words, the graphics processor may allocate a portion of the first memory to a reprojection processing stage, and may allocate a portion of the second memory to the same reprojection processing stage. This may be useful where the free space on the first memory is enough to store a few frames for reprojection processing, but is not enough to store all data configured to be stored by the reprojection processing stage. Some resource savings may be achieved by allocating at least a portion of the first memory to the reprojection processing stage. The graphics processor may then store a first set of layers processed by the reprojection processing stage on the allocated portion of the first memory after the allocation of the portion of the first memory and store a second set of layers processed by reprojection processing stage on the allocated portion of the second memory after the allocation of the portion of the second memory. The graphics processor may write-protect the allocated portion of the first memory after storage of the first set of layers processed by the reprojection processing stage. In other words, the graphics processor may prevent the reprojection processing stage from self-evicting the data stored on the first memory storage. Storage of the second set of layers on the allocated portion of the second memory may occur after the write-protection of the allocated portion of the first memory.

The graphics processor may select a compression scheme based on the set of frame processing metrics. For example, the graphics processor may select between a lossy compression scheme, or a lossless compression scheme, through a hardware processing pipeline. The lossless compression scheme may use high pixel content, or higher cache sizes, while the lossy compression scheme may use a comparatively reduced cache size for low pixel content. The graphics processor may compress a set of layers processed by the set of reprojection processing stages based on the selected compression scheme. The graphics processor may store the compressed set of layers on the allocated portion of the on-chip memory after the allocation of the portion of the on-chip memory. To select the compression scheme based on the set of frame processing metrics, the graphics processor may select the compression scheme based on a fill-rate associated with a reprojection stage of the plurality of reprojection stages or select the compression scheme based on a frame rate associated with the reprojection stage of the plurality of reprojection stages. In other words, the graphics processor may switch between lossy and lossless compression schemes at a frame level, based on the fill-rate and/or the frame rate being the tuning factor, or decisive threshold. To select the compression scheme based on the set of frame processing metrics, the graphics processor may select the compression scheme based on a type of hardware data path associated with a reprojection stage of the plurality of reprojection stages. For example, the graphics processor may select lossy compression for remotely rendered layers and lossless compression for locally rendered layers, or vice versa. The graphics processor may be implemented on a wireless communication device, such as a mobile phone or an HMD.

Particular aspects of the subject matter described in this disclosure can be implemented to realize one or more of the following potential advantages. In some examples, by allocating on-chip cache based on a predictive computation of estimated bandwidth savings per memory unit, the described techniques can be used to allocate on-chip cache to the reprojection processing stages that would result in the most efficient cache usage.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

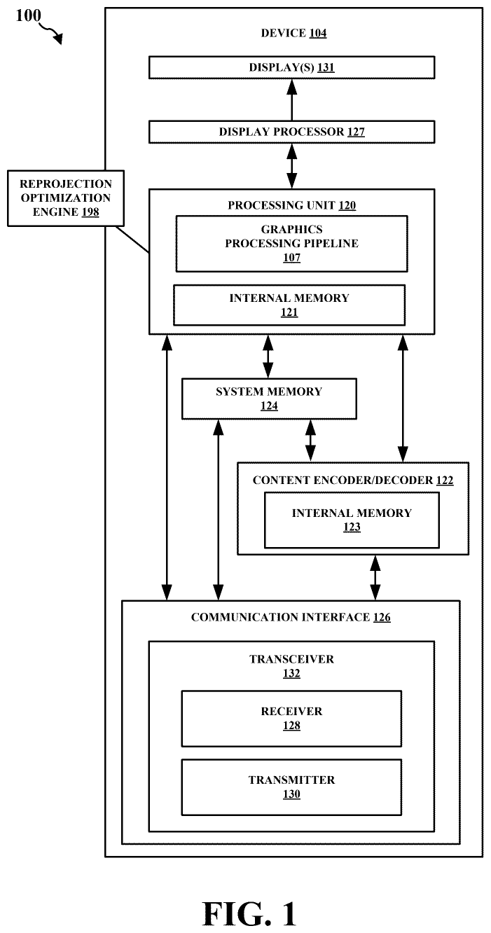

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors. A set of processors configured to perform a set of tasks may be configured to perform the set of tasks individually, or in any combination.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a reprojection optimization engine 198 configured to obtain a set of frame processing metrics from a plurality of reprojection processing stages. The reprojection optimization engine 198 may be configured to determine an estimated bandwidth savings for each reprojection processing stage of the plurality of reprojection processing stages based on the set of frame processing metrics. The reprojection optimization engine 198 may be configured to determine a priority for each of the plurality of reprojection processing stages based on the determined estimated bandwidth savings. The reprojection optimization engine 198 may be configured to allocate a portion of an on-chip memory to a set of reprojection processing stages of the plurality of reprojection processing stages based on the determined priority for each of the plurality of reprojection processing stages. Although the following description may be focused on graphics processing, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

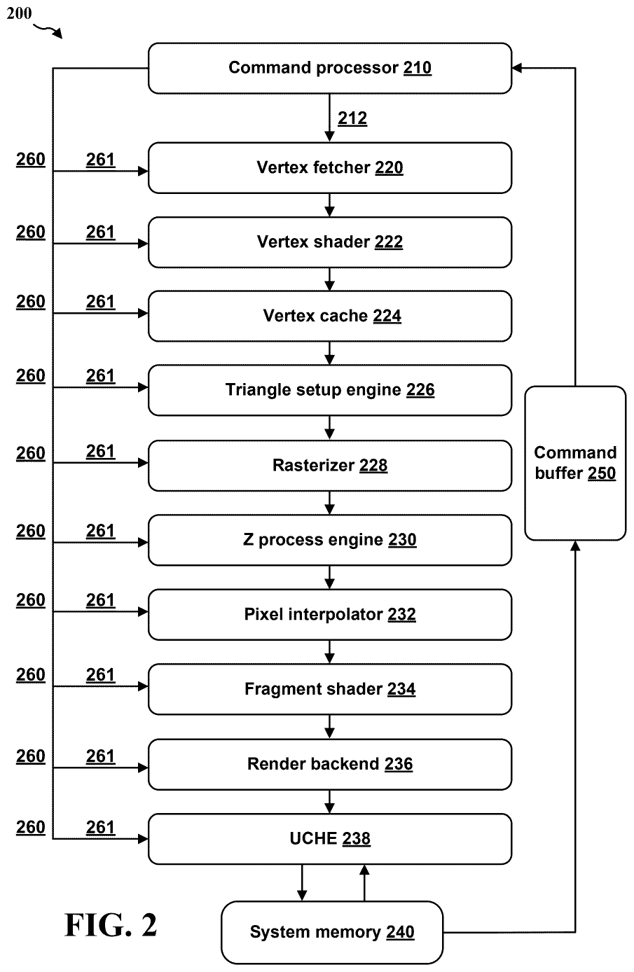

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call data packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

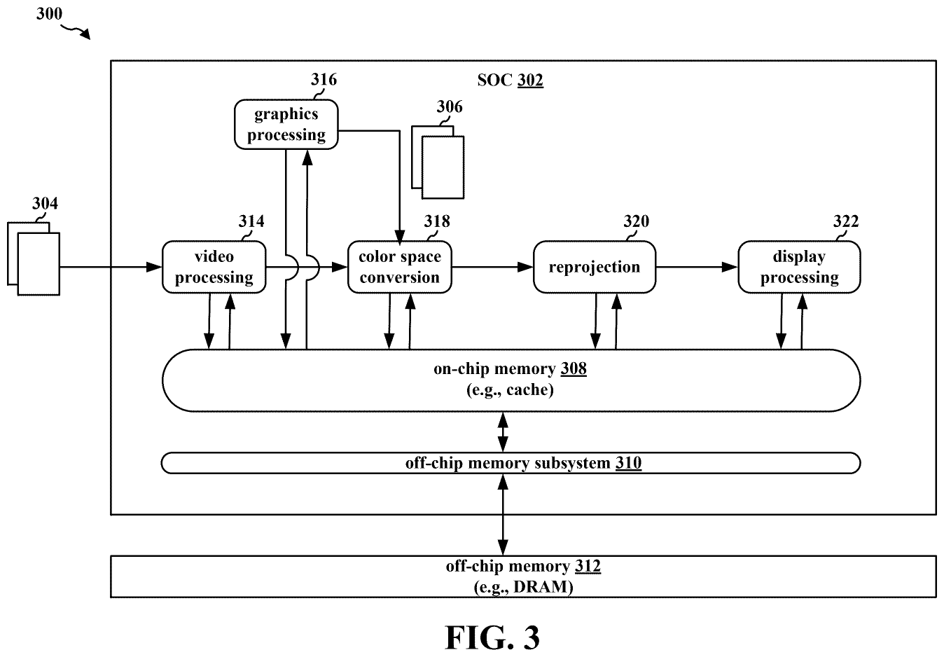

FIG. 3 is a diagram 300 of a SOC 302 configured to perform LSR on a set of layers. The SOC 302 may be a system on an HMD, for example a GPU, or a co-processor of a GPU. In some aspects, the SOC 302 may receive a set of layers 304 rendered on a remote device (e.g., a server device, a companion device). The remote device may transmit the set of layers 304 to the SOC 302 for processing. The SOC 302 may have a video processing stage 314 that decodes set of layers 304. The video processing stage 314 may decompress the set of layers 304. The video processing stage 314 may decode the set of layers 304 using a codec. In some aspects, the SOC 302 may have a graphics processing stage 316 configured to render a set of layers 306. The graphics processing stage 316 may also be referred to as the GPU of the SOC 302. The set of layers 304 may be referred to as locally rendered layers. The set of layers 306 may be referred to as remotely rendered layers. The processing path for the locally rendered layers may be different from the processing path for the remotely rendered layers. A SOC 302 configured to process both locally rendered layers and remotely rendered layers may have a large memory footprint on the on-chip memory 308 for intermediate layers. The SOC 302 may have a color space conversion stage 318 that converts colors of a set of rendered layers. The SOC 302 may have a reprojection stage 320 that warps the color-converted layers based on a head pose of a user. The reprojection stage 320 may also be referred to as a reprojection hardware unit. The SOC 302 may have a reprojection stage 320 that composes the reprojected layers into a frame for display. The SOC 302 may have a display processing stage 322 that displays a frame generated by the reprojection stage 320. The display processing stage 322 may include a display processing unit (DPU) of a graphics processing system.

When one of the aforementioned stages processes a layer, for example when the video processing stage 314 decodes the set of layers 304 or the graphics processing stage renders the set of layers 306, the stage may generate intermediate rendered content, or intermediate data, which may be used to generate the final content. That intermediate data may be stored on the on-chip memory 308, or the off-chip memory 312. The on-chip memory 308 may also be referred to as on-chip cache, and may be memory that is relatively rapidly accessible by the stages of the SOC 302. The off-chip memory 312 may include, for example, DRAM, and may be memory that is relatively slower to access by the stages of the SOC 302. In other words, a store command may take longer to process if the stage stores data on the off-chip memory 312 than if the stage stores data on the on-chip memory 308. In other aspects, a read command may take longer to process if the stage reads data from the off-chip memory 312 than if the stage reads data from the on-chip memory 308. Part of the delay may be due to the fact that the off-chip memory subsystem 310 handles offloading data from the on-chip memory 308 to the off-chip memory 312 when the on-chip memory 308 runs out of space. Depending upon the limitations of on-chip memory 308, a substantial amount of data, may be evicted to the off-chip memory 312 when performing late stage reprojection. Multiple cache optimization techniques may be deployed to achieve a performance target, as the combined conditions for caching all concurrent data buffers for all stages of the SOC 302 may be high.

In some aspects, an LSR system may reduce the amount of space used by a reprojection processing stage by utilizing the benefits of sparsity of rendered content and bounding boxes.

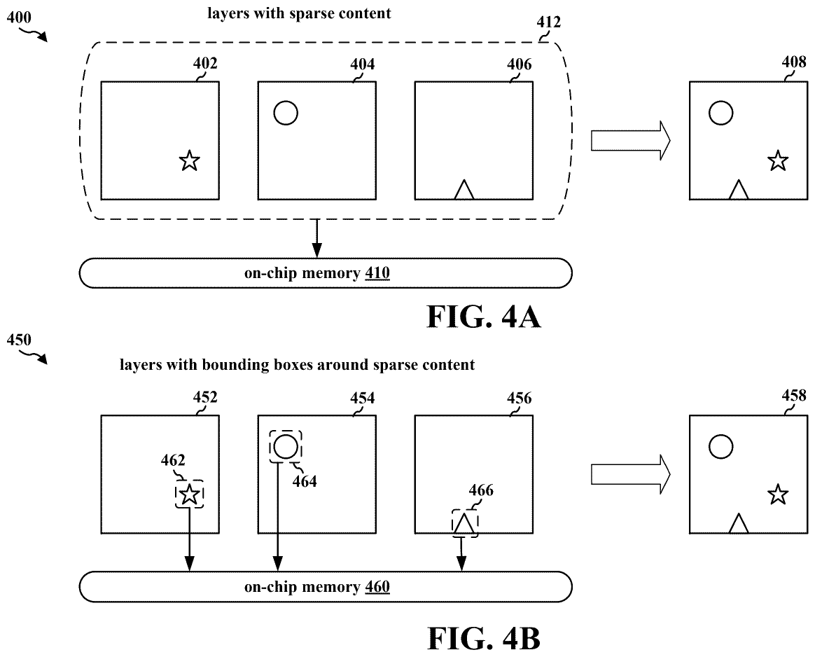

FIG. 4A is a diagram 400 illustrating sparse content that may be processed by a reprojection processing stage. A reprojection processing stage may process a layer 402, a layer 404, and a layer 406, which may be composed into a frame 408. Each of the layers may include sparse content with spatial information, for example a location of an object in a frame. An LSR system may store the layer 402, the layer 404, and the layer 406 as the sparse content 412 on a portion of the on-chip memory 410 while processing the layers. For example, the layer 402 may be an intermediate layer that may be used by a display processing stage to compose a frame, or the layer 402 may be an intermediate layer that may be decoded by a video processing stage. However, storing an entire layer on the on-chip memory 410 may be a wasteful use of on-chip memory resources.

FIG. 4B is a diagram 450 illustrating sparse content that may be processed by a reprojection processing stage. A reprojection processing stage may process a layer 452, a layer 454, and a layer 456, which may be composed into a frame 458. Each of the layers may be paired with respective bounding regions that encapsulate all pixels of the object in the layer. For example, the layer 452 may be paired with a bounding box 462, the layer 454 may be paired with a bounding box 464, and the layer 456 may be paired with a bounding box 466. A bounding box may include content localized to a small segment of an entire layer or frame. A bounding region may include spatial coordinates of a bounding box with respect to an origin point (e.g., the bottom-left corner of a layer or a frame). A reprojection processing stage may be configured to store pixel content associated with the bounding box region in the on-chip memory 460, and not pixel content located outside the bounding box region. Since the rest of the region of the layer outside of the bounding box may not have pixel information that relates to the object in the layer (i.e., is not displayed), the information within the bounding box can be stored in the on-chip memory 460 with a minimum footprint. Layer data may be stored in the on-chip memory 460 using a fast-clear scheme. The empty portion of a layer outside the bounding box may be stored as a 0 or 1 in a compressed format as metadata. A reprojection processing stage, or hardware client, accessing the on-chip memory 460 may decode the metadata to map the blank regions, thereby removing the step of reading the pixels of the layer outside of the bounding box region. Significant cost savings may be achieved by utilizing bounding boxes around sparse content. For example, 256 bytes of data may be reduced to a single byte of stored data, thereby significantly reducing the memory footprint for storing data outside of a bounding box region. Further cost savings may be achieved by analyzing the memory footprint that each reprojection processing stage has on memory.

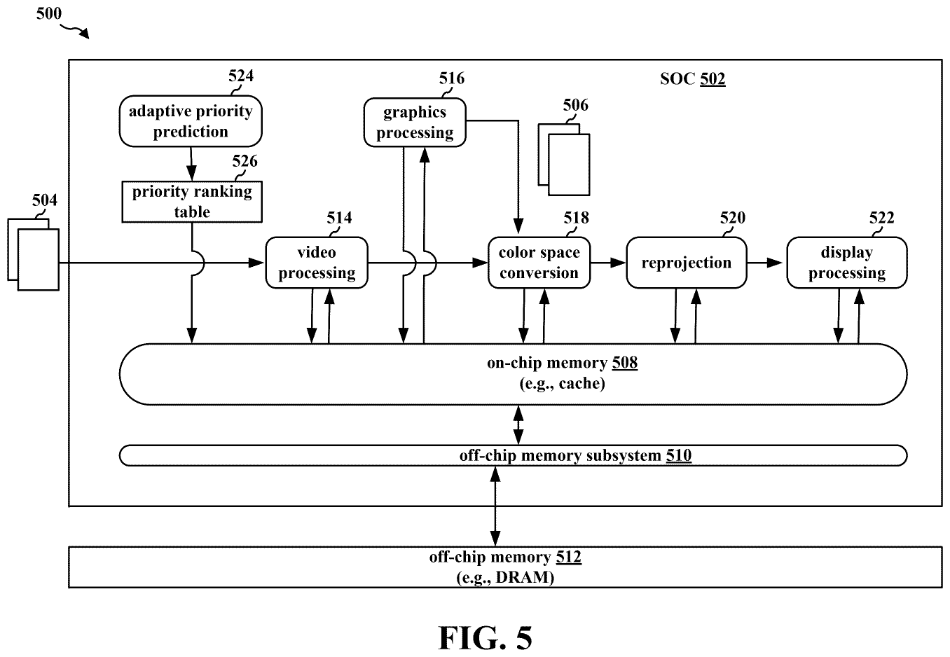

FIG. 5 is a diagram 500 of a SOC 502 configured to perform LSR on a set of layers. The SOC 502 may be a system on an HMD, for example a chip of a GPU. In some aspects, the SOC 502 may receive a set of layers 504 rendered on a remote device (e.g., a server device, a companion device). The remote device may transmit the set of layers 504 to the SOC 502 for processing. The SOC 502 may have a video processing stage 514 that decodes set of layers 504. The video processing stage 514 may decompress the set of layers 504. The video processing stage 514 may decode the set of layers 504 using a codec. In some aspects, the SOC 502 may have a graphics processing stage 516 configured to render a set of layers 506. The graphics processing stage 516 may also be referred to as the GPU of the SOC 502. The set of layers 504 may be referred to as locally rendered layers. The set of layers 506 may be referred to as remotely rendered layers. The processing path for the locally rendered layers may be different from the processing path for the remotely rendered layers. A SOC 502 configured to process both locally rendered layers and remotely rendered layers may have a large memory footprint on the on-chip memory 508 for intermediate layers. The SOC 502 may have a color space conversion stage 518 that converts colors of a set of rendered layers. The SOC 502 may have a reprojection stage 520 that warps the color-converted layers based on a head pose of a user. The reprojection stage 520 may also be referred to as a reprojection hardware unit. The SOC 502 may have a display processing stage 522 that composes the reprojected layers into a frame for display. The display processing stage 522 may include a display processing unit (DPU) of a graphics processing system.

When one of the aforementioned stages processes a layer, for example when the video processing stage 514 decodes the set of layers 504 or the graphics processing stage renders the set of layers 506, the stage may generate intermediate rendered content, or intermediate data, which may be used to generate the final content. That intermediate data may be stored on the on-chip memory 508, or the off-chip memory 512. The on-chip memory 508 may also be referred to as on-chip cache, and may be memory that is relatively rapidly accessible by the stages of the SOC 502. The off-chip memory 512 may include, for example, DRAM, and may be memory that is relatively slower to access by the stages of the SOC 502. In other words, a store command may take longer to process if the stage stores data on the off-chip memory 512 than if the stage stores data on the on-chip memory 508. In other aspects, a read command may take longer to process if the stage reads data from the off-chip memory 512 than if the stage reads data from the on-chip memory 508. Part of the delay may be due to the fact that the off-chip memory subsystem 510 handles offloading data from the on-chip memory 508 to the off-chip memory 512 when the on-chip memory 508 runs out of space.

The reprojection hardware data paths for the SOC 502 may vary depending upon the source of the rendered content. For example, the set of layers 504 may be remotely rendered and may be decoded by the video processing stage 514, whereas the set of layers 506 may be locally rendered at the graphics processing stage 516. A hardware data path of a layer may have multiple stages of intermediate processing. With increasing resolutions, increasing fill rates, increasing numbers of rendered layers, and/or increasing reprojection frame rates, the amount of storage used by a reprojection processing stage may also increase. In other words, there may be significant complexities and limitation to store all data buffers on on-chip memory 508.

Each of the reprojection processing stages may have different frame processing metrics. For example, for a given frame, the frame processing metrics for the output of a video processing stage 514 (e.g., output of layers from the video processing stage 514 to the color space conversion stage 318) may have a 100% fill rate at 60 fps and 720p, the graphics processing stage 516 (e.g., output of layers from the graphics processing stage 516 to the color space conversion stage 518) may have a 50% fill rate at 90 fps and 1080p, the color space conversion stage 518 (e.g., output of layers from the color space conversion stage 518 to the reprojection stage 520) may have a 100% fill rate at 60 fps and 720p for the remotely rendered layers, and a 50% fill rate at 90 fps and 1080p, and the reprojection stage 520 (e.g., output of layers from the reprojection stage 520 to the display processing stage 522) may have a 100% fill rate at 90fps and 1.2 MP. The display processing stage 522 may have a 100% fill rate. The display processing stage may have the same refresh rate as that of the reprojection stage 720, or the SOC 702. The fill rates may be differentiated and/or specified based on local or remote paths. A reprojection processing stage on a local path may have a 50% fill rate, while a reprojection processing stage on a remote path may have a 100% fill rate. As the data proceeds down the path to the display processing stage 522, the fill rates may increase to a 100% fill rate.

An adaptive priority prediction engine 524 may perform predictive computation to maintain a scoreboard of various producer-consumer clients accessing memory. The adaptive priority prediction engine 524 may obtain frame processing metrics from the reprojection processing stages to estimate bandwidth savings when the intermediate data is stored on the on-chip memory 508 vs. the off-chip memory 512. The evaluation factor may be to compute potential bandwidth savings per megabyte (MB) of cache stored on the on-chip memory 508. The adaptive priority prediction engine 524 may have a higher weight for a producer-consumer pair with higher savings per memory unit (e.g., per MB), accounting for expected frame rates, resolution, and fill rates. The adaptive priority prediction engine 524 may generate a priority ranking table 526 based on the predictive computation. The priority ranking table 526 may also be stored on the on-chip memory 508. Based on the predicted bandwidth savings per MB on-chip memory at the frame level, the cache may prioritize reprojection processing stages that maximize bandwidth savings. The adaptive priority prediction engine 524 may update the priority ranking table 526 dynamically on a per-frame basis, ensuring efficient cache usage during LSR.

A producer-consumer pair may refer to a pair of reprojection processing stages, where the first reprojection processing stage produces an output that is used as an input to the second reprojection processing stage. In some aspects, a reprojection processing stage may both produce and consume data. For example, the color space conversion stage 518 may consume data from the video processing stage 514, but may produce data for the reprojection stage 520. The display processing stage 522 (e.g., a DPU engine) may consume data from the reprojection stage 520, but may not produce data for any other reprojection processing stages. The graphics processing stage may produce data for the color space conversion stage 518, but may not consume data from other reprojection processing stages.

In one example, the priority ranking table 526 may prioritize storing intermediate layer outputs from the reprojection stage 520 and the color space conversion stage 518 on the on-chip memory 508, and may store outputs from the graphics processing stage 516 and the video processing stage 514 on the off-chip memory 512. In other words, the adaptive priority prediction engine 524 may determine that there will be larger estimated bandwidth savings to store intermediate layers from the reprojection stage 520 and the color space conversion stage 518 on the on-chip memory 508 than intermediate layers from the graphics processing stage 516 and the video processing stage 514. The adaptive priority prediction engine 524 may recalculate its predictive computation at a frame level to ensure efficient cache usage.

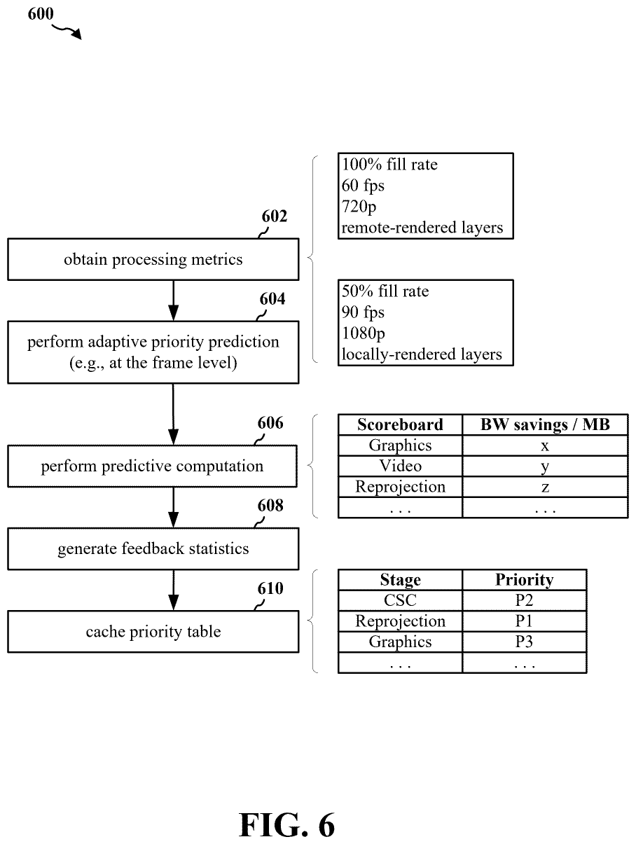

FIG. 6 is a flowchart 600 of a method of determining a priority ranking for a plurality of reprojection processing stages, in accordance with one or more techniques of this disclosure. The method may be performed by an apparatus, such as an apparatus for graphics processing, a GPU, a CPU, a co-processor, a wireless communication, and the like, as used in connection with the aspects of FIGS. 1-3, 4A, 4B, and 5.

At 602, the apparatus may obtain processing metrics, for example a frame rate (e.g., 60 fps, 90 fps), a resolution (e.g., 720p, 1080p), a fill rate (e.g., 100%, 50%), and/or a hardware datapath (e.g., remote rendered frames, locally rendered frames). The apparatus may obtain the processing metrics from a reprojection processing stage, such as a video processing stage or a color space conversion stage.

At 604, the apparatus may perform adaptive priority prediction on a plurality of reprojection processing stages. The apparatus performs the adaptive priority prediction at a frame level. In other words, the apparatus may dynamically perform priority prediction for each frame being processed by an LSR system.

At 606, the apparatus may perform predictive computation on each of the plurality of reprojection processing stages. The apparatus may compute a projected bandwidth savings per megabyte (MB) of data stored on an on-chip memory, where the MB of data is generated by the respective reprojection processing stage. For example, the apparatus may compute that a graphics processing stage that produces data to be output to a reprojection processing stage is estimated to save x bandwidth per MB stored on the on-chip memory, that a video processing stage that produces data to be output to a reprojection processing stage is estimated to save y bandwidth per MB stored on the on-chip memory, and that a reprojection processing stage that produces data to be output to a display processing stage is estimated to save z bandwidth per MB stored on the on-chip memory.

At 608, the apparatus may generate feedback statistics for use by a reprojection optimization engine. The feedback statistics may be in the form of a priority ranking table based on the estimated bandwidth savings from 606.

At 610, the apparatus may cache a priority table, also referred to as a priority ranking table, on an on-chip memory. The priority table may indicate that data from a reprojection processing stage should have the highest priority to store data on the on-chip memory, followed by a color space conversion stage, followed by a graphics processing stage.

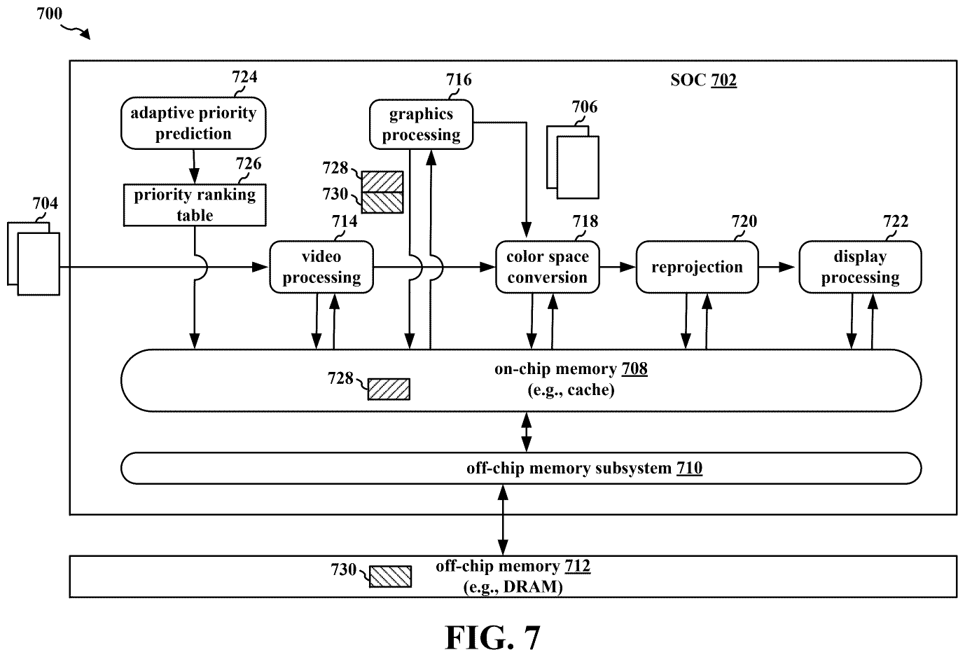

FIG. 7 is a diagram 700 of a SOC 702 configured to perform LSR on a set of layers. The SOC 702 may be a system on an HMD, for example a chip of a GPU. In some aspects, the SOC 702 may receive a set of layers 704 rendered on a remote device (e.g., a server device, a companion device). The remote device may transmit the set of layers 704 to the SOC 702 for processing. The SOC 702 may have a video processing stage 714 that decodes set of layers 704. The video processing stage 714 may decompress the set of layers 704. The video processing stage 714 may decode the set of layers 704 using a codec. In some aspects, the SOC 702 may have a graphics processing stage 716 configured to render a set of layers 706. The graphics processing stage 716 may also be referred to as the GPU of the SOC 702. The set of layers 704 may be referred to as remotely rendered layers. The set of layers 706 may be referred to as locally rendered layers. The processing path for the locally rendered layers may be different from the processing path for the remotely rendered layers. A SOC 702 configured to process both locally rendered layers and remotely rendered layers may have a large memory footprint on the on-chip memory 708 for intermediate layers. The SOC 702 may have a color space conversion stage 718 that converts colors of a set of rendered layers. The SOC 702 may have a reprojection stage 720 that warps the color-converted layers based on a head pose of a user. The reprojection stage 720 may also be referred to as a reprojection hardware unit. The SOC 702 may have a display processing stage 722 that composes the reprojected layers into a frame for display. The display processing stage 722 may include a display processing unit (DPU) of a graphics processing system.

The reprojection hardware data paths for the SOC 702 may vary depending upon the source of the rendered content. For example, the set of layers 704 may be remotely rendered and may be decoded by the video processing stage 714, whereas the set of layers 706 may be locally rendered at the graphics processing stage 716. A hardware data path of a layer may have multiple stages of intermediate processing. With increasing resolutions, increasing fill rates, increasing numbers of rendered layers, and/or increasing reprojection frame rates, the amount of storage used by a reprojection processing stage may also increase. In other words, there may be significant complexities and limitation to store all data buffers on on-chip memory 708.

Each of the reprojection processing stages may have different frame processing metrics. For example, for a given frame, the frame processing metrics for the output of a video processing stage 714 (e.g., output of layers from the video processing stage 714 to the color space conversion stage 318) may have a 100% fill rate at 60 fps and 720p, the graphics processing stage 716 (e.g., output of layers from the graphics processing stage 716 to the color space conversion stage 718) may have a 70% fill rate at 90 fps and 1080p, the color space conversion stage 718 (e.g., output of layers from the color space conversion stage 718 to the reprojection stage 720) may have a 100% fill rate at 60 fps and 720p for the remotely rendered layers, and a 70% fill rate at 90 fps and 1080p, and the reprojection stage 720 (e.g., output of layers from the reprojection stage 720 to the display processing stage 722) may have a 100% fill rate at 90 fps and 1.2 MP. An adaptive priority prediction engine 724 may perform predictive computation to maintain a scoreboard of various producer-consumer clients accessing memory. The adaptive priority prediction engine 724 may obtain frame processing metrics from the reprojection processing stages to estimate bandwidth savings when the intermediate data is stored on the on-chip memory 708 vs. the off-chip memory 712. The evaluation factor may be to compute potential bandwidth savings per megabyte (MB) of cache stored on the on-chip memory 708. The adaptive priority prediction engine 724 may have a higher weight for a producer-consumer pair with higher savings, accounting for expected frame rates, resolution, and fill rates. The adaptive priority prediction engine 724 may generate a priority ranking table 726 based on the predictive computation. The priority ranking table 726 may also be stored on the on-chip memory 708. Based on the predicted bandwidth savings per MB on-chip memory at the frame level, the cache may prioritize reprojection processing stages that maximize bandwidth savings. The adaptive priority prediction engine 724 may update the priority ranking table 726 dynamically on a per-frame basis, ensuring efficient cache usage during LSR.

In one example, the priority ranking table 726 may prioritize storing intermediate layer outputs from the reprojection stage 720 and the color space conversion stage 718 on the on-chip memory 708, and may store outputs from the graphics processing stage 716 and the video processing stage 714 on the off-chip memory 712. In other words, the adaptive priority prediction engine 724 may determine that there will be larger estimated bandwidth savings to store intermediate layers from the reprojection stage 720 and the color space conversion stage 718 on the on-chip memory 708 than intermediate layers from the graphics processing stage 716 and the video processing stage 714. The adaptive priority prediction engine 724 may recalculate its predictive computation at a frame level to ensure efficient cache usage.

When one of the aforementioned stages processes a layer, for example when the video processing stage 714 decodes the set of layers 704 or the graphics processing stage renders the set of layers 706, the stage may generate intermediate rendered content, or intermediate data, which may be used to generate the final content. That intermediate data may be stored on the on-chip memory 708, or the off-chip memory 712. The on-chip memory 708 may also be referred to as on-chip cache, and may be memory that is relatively rapidly accessible by the stages of the SOC 702. The off-chip memory 712 may include, for example, DRAM, and may be memory that is relatively slower to access by the stages of the SOC 702. In other words, a store command may take longer to process if the stage stores data on the off-chip memory 712 than if the stage stores data on the on-chip memory 708. In other aspects, a read command may take longer to process if the stage reads data from the off-chip memory 712 than if the stage reads data from the on-chip memory 708. Part of the delay may be due to the fact that the off-chip memory subsystem 710 handles offloading data from the on-chip memory 708 to the off-chip memory 712 when the on-chip memory 708 runs out of space.

In some aspects, a reprojection optimization engine may store a portion of the intermediate rendered content generated by a reprojection processing stage on the on-chip memory 708 and another portion of the intermediate rendered content generated by the same reprojection processing stage on the off-chip memory 712. In other words, based on the priority ranking table 726, the reprojection optimization engine will store a partial portion of a frame generated for some producer-consumer clients with lower priority due to limited availability of on-chip memory. Without proper handling, the partially written frame on the on-chip memory may be replayed by the rest of the frame data by the same client, which may lead to loss of potential bandwidth savings. In other words, a reprojection processing stage may accidentally self-evict data generated by the reprojection processing stage. In order to prevent this, the reprojection optimization engine may be configured to enable a feature called no self-evict, where the hardware client cannot evict the partial data of the frame it produced.

For example, here, the graphics processing stage 716 may generate the set of data 728 and the set of data 730. The set of data 728 and the set of data 730 may be two portions of an intermediate frame. For example, the set of data 728 may represent a first set of layers and the set of data 730 may represent a second set of layers for the same frame. The reprojection optimization engine may cache the set of data 728 on the on-chip memory 708. In order to prevent the graphics processing stage 716 from accidentally self-evicting the set of data 728 from the on-chip memory 708 with the set of data 730, the reprojection optimization engine may enable a feature called no self-evict, which prevents the graphics processing stage 716 from evicting the partial data of the frame it produced. In other words, the reprojection optimization engine may write-protect the allocated portion of the on-chip memory 708 allocated to the graphics processing stage 716 for storing the set of data 728 after storage of the set of data 728 until the set of data 728 has been retrieved by the next stage (e.g., the color space conversion stage 718). The reprojection optimization engine may then store the rest of the partial frame, the set of data 730, onto the off-chip memory 712 via the off-chip memory subsystem 710. This scheme ensures additional partial frame bandwidth savings, by eliminating the possibility of the client evicting its cache-lines or own data. In other words, the graphics processing stage 716 is prevented from evicting the set of data 728 when trying to store the set of data 730 on a cached memory.

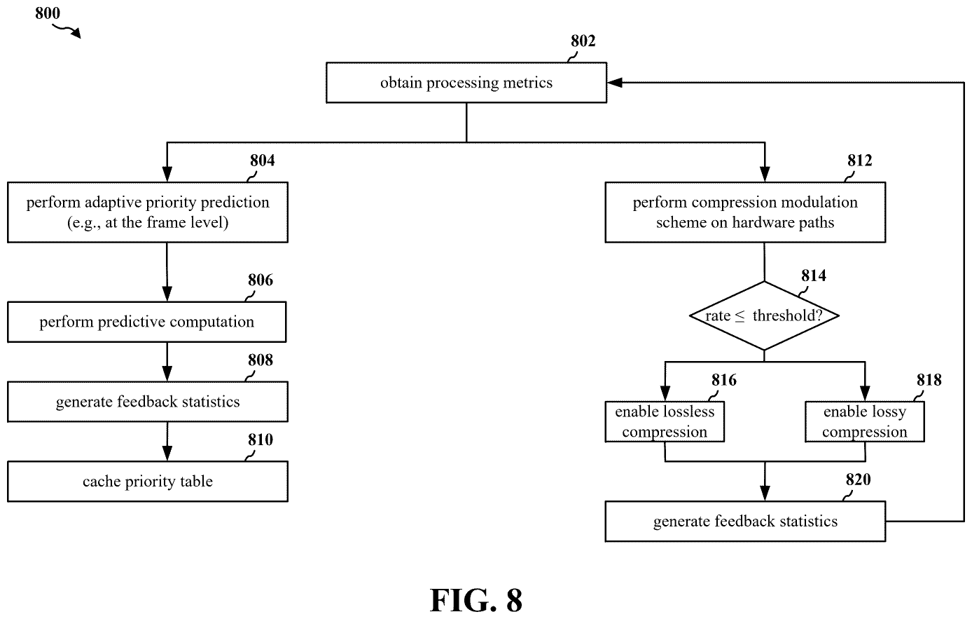

FIG. 8 is a flowchart 800 of a method of determining a priority ranking for a plurality of reprojection processing stages and a compression scheme for a set of layers, in accordance with one or more techniques of this disclosure. The method may be performed by an apparatus, such as an apparatus for graphics processing, a GPU, a CPU, a co-processor, a wireless communication, and the like, as used in connection with the aspects of FIGS. 1-3, 4A, 4B, and 5-7.

In some aspects, a reprojection optimization engine may use a dynamic compression modulation scheme that switches between lossy and lossless compression modes, based on fill-rate and/or based on frame rate being the decisive threshold. In other words, the fill-rate and/or frame rate may be the tuning factor for a compression modulation scheme at a frame level. The reprojection optimization engine may subject the rendered layers, intermediate processed layers, and/or composed layers to consistent compression schemes through a hardware processing pipeline. Lossless compression may translate to comparatively higher pixel content and comparatively higher cache size conditions, whereas lossy compression may translate to comparatively reduced pixel content and comparatively lower cache size conditions. The reprojection optimization engine may opt for a lossless compression mode for smaller fill rates. The reprojection optimization engine may opt for a lossless compression mode for smaller frame rates. The reprojection optimization engine may opt for a lossy compression mode for larger fill rates. The reprojection optimization engine may opt for a lossy compression mode for larger frame rates. In some aspects, the local and remote paths may have different compression factors and tunable bit-width for lossy modes, ensuring the functionality of reprojection in high workload use cases. This tunable threshold level may provide the ability to dynamically increase the compression of a high workload data path based on the threshold level.

At 802, the apparatus may obtain processing metrics, for example a frame rate (e.g., 80 fps, 90 fps), a resolution (e.g., 720p, 1080p), a fill rate (e.g., 100%, 50%), and/or a hardware datapath (e.g., remote rendered frames, locally rendered frames). The apparatus may obtain the processing metrics from a reprojection processing stage, such as a video processing stage or a color space conversion stage.

At 804, the apparatus may perform adaptive priority prediction on a plurality of reprojection processing stages. The apparatus may perform the adaptive priority prediction at a frame level. In other words, the apparatus may dynamically perform priority prediction for each frame being processed by an LSR system.

At 806, the apparatus may perform predictive computation on each of the plurality of reprojection processing stages. The apparatus may compute a projected bandwidth savings per megabyte (MB) of data stored on an on-chip memory, where the MB of data is generated by the respective reprojection processing stage. For example, the apparatus may compute that a graphics processing stage that produces data to be output to a reprojection processing stage is estimated to save x bandwidth per MB stored on the on-chip memory, that a video processing stage that produces data to be output to a reprojection processing stage is estimated to save y bandwidth per MB stored on the on-chip memory, and that a reprojection processing stage that produces data to be output to a display processing stage is estimated to save z bandwidth per MB stored on the on-chip memory.

At 808, the apparatus may generate feedback statistics for use by a reprojection optimization engine. The feedback statistics may be in the form of a priority ranking table based on the estimated bandwidth savings from 806.

At 810, the apparatus may cache a priority table, also referred to as a priority ranking table, on an on-chip memory. The priority table may indicate that data from a reprojection processing stage should have the highest priority to store data on the on-chip memory, followed by a color space conversion stage, followed by a graphics processing stage.

At 812, the apparatus may perform a compression modulation scheme on hardware data paths. The modulation scheme may be different on a local hardware data path than on a remote hardware data path. In other words, frames that have been rendered remotely may have a different compression scheme threshold than frames that have been rendered locally. For example, the compression scheme for storing data from the graphics processing stage 716 may be different than the compression scheme for storing data from the video processing stage 714 in FIG. 7.

At 814, the apparatus may determine whether the rate (e.g., fill rate, frame rate, fill rate and frame rate) is less than or equal to a threshold level. If the rate is less than or equal to the threshold level, at 816 the apparatus may enable lossless compression. If the rate is greater than the threshold level, at 818 the apparatus may enable lossy compression. In other words, the apparatus may enable lossless compression for a lower fill rate and/or a lower resolution layer, ensuring that the apparatus maintains a quality of a display frame. The apparatus may enable lossy compression for a higher fill rate and/or a higher resolution layer, to improve cache footprint management and/or maintains a minimum throughput (e.g., 15 fps, 30 fps).

At 820, the apparatus may generate feedback statistics for use by a reprojection optimization engine. The feedback statistics may be in the form of a compression mode (e.g., lossy compression vs. lossless compression) for a set of layers generated by a reprojection processing stage. The feedback statistics may be in the form of a bit-width (e.g., 8-bit vs. 10-bit) associated with the compression mode. Such stats may be used by the predictive computation at 806 to adjust the projected bandwidth savings, as a lossy compression mode may incur higher bandwidth savings than a lossless compression mode.

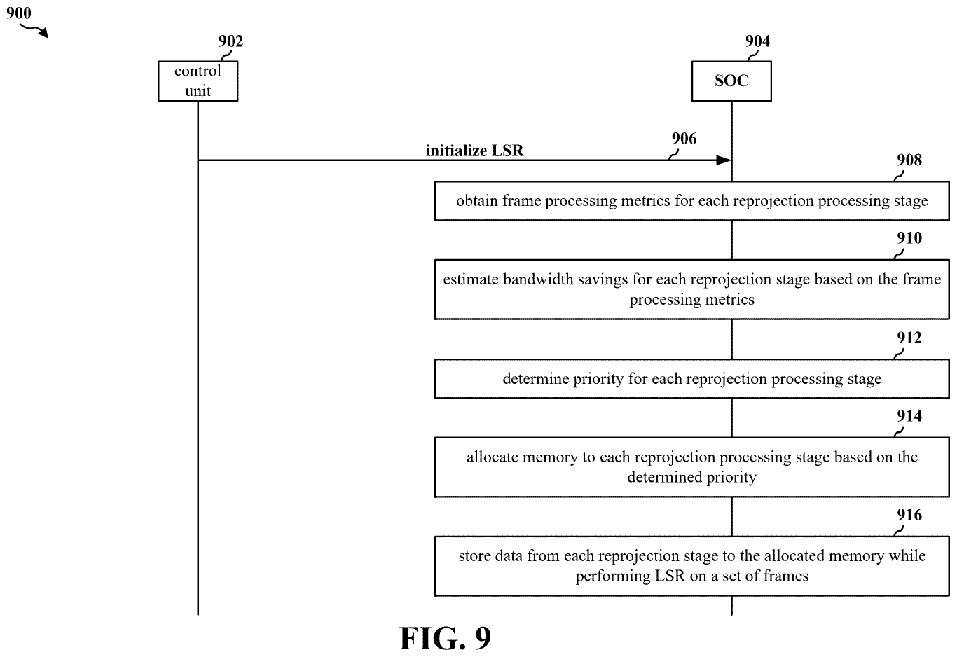

FIG. 9 is a call flow diagram 900 illustrating example communications between a control unit 902 and a SOC 904, in accordance with one or more techniques of this disclosure. The control unit 902 may be a CPU. The SOC 904 may be a GPU, DPU, or a co-processor.

The control unit 902 may output an indication 906 to initialize a LSR of a set of frames to the SOC 904. At 908, the SOC may obtain frame processing metrics for each reprojection stage. At 910, the SOC may estimate bandwidth savings for each reprojection stage based on the frame processing metrics. At 912, the SOC may determine priority for each reprojection processing stage. At 914, the SOC may allocate memory to each reprojection processing stage based on the determined priority. At 916, the SOC may store data from each reprojection stage to the allocated memory while performing LSR on a set of frames.

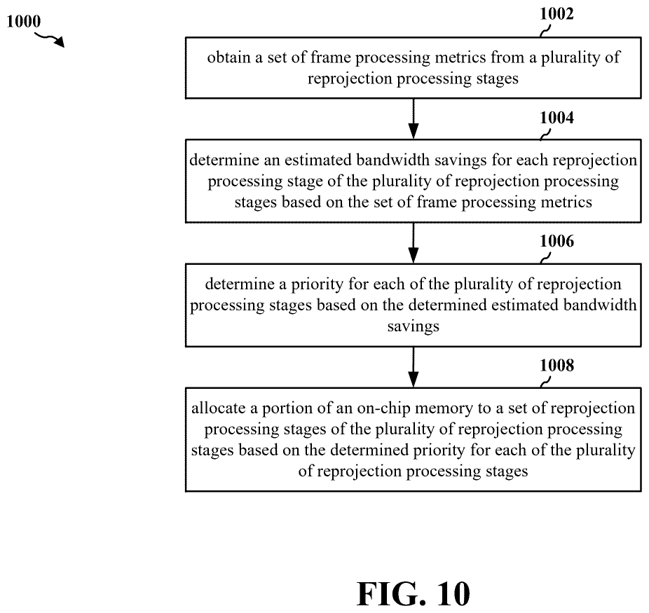

FIG. 10 is a flowchart 1000 of an example method of graphics processing in accordance with one or more techniques of this disclosure. The method may be performed by an apparatus, such as an apparatus for graphics processing, a GPU, a CPU, a co-processor, a wireless communication device, and the like, as used in connection with the aspects of FIGS. 1-3, 4A, 4B, and 5-9.

At 1002, the apparatus may obtain a set of frame processing metrics from a plurality of reprojection processing stages. For example, referring to FIG. 9, the SOC 904 may perform 1002 to obtain a set of frame processing metrics from a plurality of reprojection processing stages. Moreover, 1002 may be performed by the reprojection optimization engine 198.

At 1004, the apparatus may determine an estimated bandwidth savings for each reprojection processing stage of the plurality of reprojection processing stages based on the set of frame processing metrics. For example, referring to FIG. 9, the SOC 904 may perform 1004 to determine an estimated bandwidth savings for each reprojection processing stage of the plurality of reprojection processing stages based on the set of frame processing metrics. Moreover, 1004 may be performed by the reprojection optimization engine 198.

At 1006, the apparatus may determine a priority for each of the plurality of reprojection processing stages based on the determined estimated bandwidth savings. For example, referring to FIG. 9, the SOC 904 may perform 1006 to determine a priority for each of the plurality of reprojection processing stages based on the determined estimated bandwidth savings. Moreover, 1006 may be performed by the reprojection optimization engine 198.

At 1008, the apparatus may allocate a portion of an on-chip memory to a set of reprojection processing stages of the plurality of reprojection processing stages based on the determined priority for each of the plurality of reprojection processing stages. For example, referring to FIG. 9, the SOC 904 may perform 1008 to allocate a portion of an on-chip memory to a set of reprojection processing stages of the plurality of reprojection processing stages based on the determined priority for each of the plurality of reprojection processing stages. Moreover, 1008 may be performed by the reprojection optimization engine 198.

In configurations, a method or an apparatus for graphics processing is provided. The apparatus may be a GPU, a CPU, or some other processor that may perform graphics processing. In aspects, the apparatus may be the processing unit 120 within the device 104, or may be some other hardware within the device 104 or another device. The apparatus may include means for obtaining a set of frame processing metrics from a plurality of reprojection processing stages. The apparatus may further include means for determining an estimated bandwidth savings for each reprojection processing stage of the plurality of reprojection processing stages based on the set of frame processing metrics. The apparatus may further include means for determining a priority for each of the plurality of reprojection processing stages based on the determined estimated bandwidth savings. The apparatus may further include means for allocating a portion of an on-chip memory to a set of reprojection processing stages of the plurality of reprojection processing stages based on the determined priority for each of the plurality of reprojection processing stages.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

An indication of a set of data may include the data itself, or a reference to the data, for example a memory address where the data may be retrieved by the receiving entity, or an index to a set of data (e.g., an index of 1 that represents the series of bits 1100101). A single indication may also include a set of indications, for example an array of memory addresses or a plurality of index references.

The following aspects are illustrative only and may be combined with other aspects or teachings described herein, without limitation.
Aspect 1 is a method of graphics processing, comprising: obtaining a set of frame processing metrics from a plurality of reprojection processing stages; determining an estimated bandwidth savings for each reprojection processing stage of the plurality of reprojection processing stages based on the set of frame processing metrics; determining a priority for each of the plurality of reprojection processing stages based on the determined estimated bandwidth savings; and allocating a portion of a first memory to a set of reprojection processing stages of the plurality of reprojection processing stages based on the determined priority for each of the plurality of reprojection processing stages. The first memory may include an on-chip memory, for example on-chip cache. The estimated bandwidth savings may be calculated per memory unit, for example MB/s for every MB of data saved on an on-chip cache.
Aspect 2 is the method of aspect 1, further comprising: storing a set of layers processed by the set of reprojection processing stages on the allocated portion of the first memory after the allocation of the portion of the first memory.
Aspect 3 is the method of either of aspects 1 or 2, wherein determining the priority for each of the plurality of reprojection processing stages based on the determined estimated bandwidth savings comprises: determining a priority ranking table for the plurality of reprojection stages for a first frame of a plurality of frames, further comprising: storing the priority ranking table on a second portion of the first memory.
Aspect 4 is the method of any of aspects 1 to 3, further comprising: allocating a portion of a second memory to a second set of reprojection processing stages of the plurality of reprojection processing stages based on the determined priority for each of the plurality of reprojection processing stages.
Aspect 5 is the method of aspect 4, further comprising: storing a second set of layers processed by the second set of reprojection stages on the allocation portion of the second memory after the allocation of the portion of the second memory.
Aspect 6 is the method of any of aspects 1 to 5, wherein the set of frame processing metrics comprises at least one of: a frame rate associated with a reprojection stage of the plurality of reprojection stages; a resolution associated with the reprojection stage; a fill rate associated with the reprojection stage; or an identifier associated with the reprojection stage.
Aspect 7 is the method of aspect 6, wherein determining the estimated bandwidth savings for each reprojection stage of the plurality of reprojection processing stages based on the set of frame processing metrics comprises: determining the estimated bandwidth savings for the reprojection stage based on the frame rate, the resolution, and the fill rate associated with the reprojection stage.
Aspect 8 is the method of any of aspects 1 to 7, wherein determining the priority for each of the plurality of reprojection processing stages based on the determined estimated bandwidth savings comprises: determining a first priority ranking for the plurality of reprojection stages for a first frame of a plurality of frames; and determining a second priority ranking for the plurality of reprojection stages for a second frame of the plurality of frames, wherein allocating the portion of the first memory to the set of reprojection processing stages of the plurality of reprojection processing stages based on the determined priority for each of the plurality of reprojection processing stages comprises: allocating a first portion of the first memory to a first set of reprojection processing stages of the plurality of reprojection processing stages based on the determined first priority ranking; and allocating a second portion of the first memory to a second set of reprojection processing stages of the plurality of reprojection processing stages based on the determined second priority ranking, wherein the first set of reprojection processing stages is different from the second set of reprojection processing stages.
Aspect 9 is the method of any of aspects 1 to 8, wherein the plurality of reprojection processing stages comprises at least one of: a video processing stage; a graphics processing stage; a color space conversion stage; or a reprojection stage.
Aspect 10 is the method of any of aspects 1 to 9, wherein allocating the portion of the first memory to the set of reprojection processing stages of the plurality of reprojection processing stages based on the determined priority for each of the plurality of reprojection processing stages comprises: allocating the portion of the first memory to a reprojection processing stage of the plurality of reprojection processing stages based on the determined priority for each of the plurality of reprojection processing stages, further comprising: allocating a portion of a second memory to the reprojection processing stage of the plurality of reprojection processing stages based on the determined priority for each of the plurality of reprojection processing stages; storing a first set of layers processed by the reprojection processing stage on the allocated portion of the first memory after the allocation of the portion of the first memory; and storing a second set of layers processed by reprojection processing stage on the allocated portion of the second memory after the allocation of the portion of the second memory.
Aspect 11 is the method of aspect 10, further comprising: write-protecting the allocated portion of the first memory after storage of the first set of layers processed by the reprojection processing stage, wherein storage of the second set of layers on the allocated portion of the second memory occurs after the write-protection of the allocated portion of the first memory.
Aspect 12 is the method of any of aspects 1 to 11, further comprising: selecting a compression scheme based on the set of frame processing metrics; compressing a set of layers processed by the set of reprojection processing stages based on the selected compression scheme; and storing the compressed set of layers on the allocated portion of the first memory after the allocation of the portion of the first memory.
Aspect 13 is the method of aspect 12, wherein selecting the compression scheme based on the set of frame processing metrics comprises: selecting the compression scheme based on a fill-rate associated with a reprojection stage of the plurality of reprojection stages; or selecting the compression scheme based on a frame rate associated with the reprojection stage of the plurality of reprojection stages.
Aspect 14 is the method of either of aspects 12 or 13, wherein selecting the compression scheme based on the set of frame processing metrics comprises: selecting the compression scheme based on a type of hardware data path associated with a reprojection stage of the plurality of reprojection stages. For example, the compression scheme may be selected based on whether the layers are rendered remotely or locally. Locally rendered layers may be stored on memory using a more complex compression scheme than remotely rendered layers, or vice-versa.
Aspect 15 is the method of any of aspects 1 to 14, wherein the first memory comprises an on-chip cache.
Aspect 16 is the method of any of aspects 4, 5, 10, or 11, wherein the second memory comprises an off-chip system memory.
Aspect 17 is the method of any of aspects 1 to 16, wherein determining the estimated bandwidth savings for each reprojection processing stage of the plurality of reprojection processing stages based on the set of frame processing metrics comprises determining the estimated bandwidth savings per memory unit for each reprojection processing stage of the plurality of reprojection processing stages.
Aspect 18 is an apparatus for graphics processing including at least one processor coupled to a memory and configured to implement a method as in any of aspects 1-17.
Aspect 19 may be combined with aspect 18 and includes that the apparatus is a wireless communication device.
Aspect 20 is an apparatus for graphics processing including means for implementing a method as in any of aspects 1-17.
Aspect 21 is a computer-readable medium (e.g., a non-transitory computer-readable medium) storing computer executable code, the code when executed by at least one processor causes the at least one processor to implement a method as in any of aspects 1-17.

Various aspects have been described herein. These and other aspects are within the scope of the following claims.

What is claimed is:

1. An apparatus for graphics processing, comprising:
a memory; and
a processor coupled to the memory and, based at least in part on information stored in the memory, the processor is configured to:
obtain a set of frame processing metrics from a plurality of reprojection processing stages;
determine an estimated bandwidth savings for each reprojection processing stage of the plurality of reprojection processing stages based on the set of frame processing metrics;
determine a priority for each of the plurality of reprojection processing stages based on the determined estimated bandwidth savings; and
allocate a portion of a first memory to a set of reprojection processing stages of the plurality of reprojection processing stages based on the determined priority for each of the plurality of reprojection processing stages.

2. The apparatus of claim 1, wherein the processor is further configured to:
store a set of layers processed by the set of reprojection processing stages on the allocated portion of the first memory after the allocation of the portion of the first memory.

3. The apparatus of claim 1, wherein, to determine the priority for each of the plurality of reprojection processing stages based on the determined estimated bandwidth savings, the processor is configured to:
determine a priority ranking table for the plurality of reprojection stages for a first frame of a plurality of frames, wherein the processor is further configured to:
store the priority ranking table on a second portion of the first memory.

4. The apparatus of claim 1, wherein the processor is further configured to:
allocate a portion of a second memory to a second set of reprojection processing stages of the plurality of reprojection processing stages based on the determined priority for each of the plurality of reprojection processing stages, wherein the first memory is different than the second memory.

5. The apparatus of claim 4, wherein the processor is further configured to:
store a second set of layers processed by the second set of reprojection stages on the allocation portion of the second memory after the allocation of the portion of the second memory.

6. The apparatus of claim 4, wherein the second memory comprises an off-chip system memory.

7. The apparatus of claim 1, wherein the set of frame processing metrics comprises at least one of:
a frame rate associated with a reprojection stage of the plurality of reprojection stages;
a resolution associated with the reprojection stage;
a fill rate associated with the reprojection stage; or
an identifier associated with the reprojection stage.

8. The apparatus of claim 7, wherein, to determine the estimated bandwidth savings for each reprojection stage of the plurality of reprojection processing stages based on the set of frame processing metrics, the processor is configured to:
determine the estimated bandwidth savings for the reprojection stage based on the frame rate, the resolution, and the fill rate associated with the reprojection stage.

9. The apparatus of claim 1, wherein, to determine the priority for each of the plurality of reprojection processing stages based on the determined estimated bandwidth savings, the processor is configured to:
determine a first priority ranking for the plurality of reprojection stages for a first frame of a plurality of frames; and
determine a second priority ranking for the plurality of reprojection stages for a second frame of the plurality of frames, wherein, to allocate the portion of the first memory to the set of reprojection processing stages of the plurality of reprojection processing stages based on the determined priority for each of the plurality of reprojection processing stages, the processor is configured to:
allocate a first portion of the first memory to a first set of reprojection processing stages of the plurality of reprojection processing stages based on the determined first priority ranking; and
allocate a second portion of the first memory to a second set of reprojection processing stages of the plurality of reprojection processing stages based on the determined second priority ranking, wherein the first set of reprojection processing stages is different from the second set of reprojection processing stages.

10. The apparatus of claim 1, wherein the plurality of reprojection processing stages comprises at least one of:
a video processing stage;
a graphics processing stage;
a color space conversion stage;
a reprojection stage; or
a display processing stage.

11. The apparatus of claim 1, wherein, to allocate the portion of the first memory to the set of reprojection processing stages of the plurality of reprojection processing stages based on the determined priority for each of the plurality of reprojection processing stages, the processor is configured to:
allocate the portion of the first memory to a reprojection processing stage of the plurality of reprojection processing stages based on the determined priority for each of the plurality of reprojection processing stages, wherein the processor is further configured to:
allocate a portion of a second memory to the reprojection processing stage of the plurality of reprojection processing stages based on the determined priority for each of the plurality of reprojection processing stages;
store a first set of layers processed by the reprojection processing stage on the allocated portion of the first memory after the allocation of the portion of the first memory; and
store a second set of layers processed by the reprojection processing stage on the allocated portion of the second memory after the allocation of the portion of the second memory, wherein the first memory is different than the second memory.

12. The apparatus of claim 11, wherein the processor is further configured to:
write-protect the allocated portion of the first memory after storage of the first set of layers processed by the reprojection processing stage, wherein the storage of the second set of layers on the allocated portion of the second memory occurs after the write-protection of the allocated portion of the first memory.

13. The apparatus of claim 1, wherein the processor is further configured to:
select a compression scheme based on the set of frame processing metrics;
compress a set of layers processed by the set of reprojection processing stages based on the selected compression scheme; and
store the compressed set of layers on the allocated portion of the first memory after the allocation of the portion of the first memory.

14. The apparatus of claim 13, wherein, to select the compression scheme based on the set of frame processing metrics, the processor is configured to:
select the compression scheme based on a fill-rate associated with a reprojection stage of the plurality of reprojection stages; or
select the compression scheme based on a frame rate associated with the reprojection stage of the plurality of reprojection stages.

15. The apparatus of claim 13, wherein, to select the compression scheme based on the set of frame processing metrics, the processor is configured to:
select the compression scheme based on a type of hardware data path associated with a reprojection stage of the plurality of reprojection stages.

16. The apparatus of claim 1, wherein the first memory comprises an on-chip cache.

17. The apparatus of claim 1, wherein, to determine the estimated bandwidth savings for each reprojection processing stage of the plurality of reprojection processing stages based on the set of frame processing metrics, the processor is configured to:
determine an estimated bandwidth savings per memory unit for each reprojection stage of the plurality of reprojection processing stages.

18. The apparatus of claim 1, wherein the apparatus comprises a wireless communication device.

19. A method of graphics processing, comprising:
obtaining a set of frame processing metrics from a plurality of reprojection processing stages;
determining an estimated bandwidth savings for each reprojection processing stage of the plurality of reprojection processing stages based on the set of frame processing metrics;
determining a priority for each of the plurality of reprojection processing stages based on the determined estimated bandwidth savings; and
allocating a portion of a first memory to a set of reprojection processing stages of the plurality of reprojection processing stages based on the determined priority for each of the plurality of reprojection processing stages.

20. A computer-readable medium storing computer executable code, the code when executed by a processor, causes the processor to:
obtain a set of frame processing metrics from a plurality of reprojection processing stages;
determine an estimated bandwidth savings for each reprojection processing stage of the plurality of reprojection processing stages based on the set of frame processing metrics;
determine a priority for each of the plurality of reprojection processing stages based on the determined estimated bandwidth savings; and
allocate a portion of a first memory to a set of reprojection processing stages of the plurality of reprojection processing stages based on the determined priority for each of the plurality of reprojection processing stages.
